(19) United States
(12) Patent Application Publication
(10) Pub. No.: US 2011/0218910 A1
(43) Pub. Date: Sep. 8, 2011

(54) METHOD OF ESTABLISHING AN ENDOGENOUS FUTURES MARKET FOR POLLUTANT EMISSION FEES

(76) Inventor: Anders L. Hoglund, Kungsbacka (SE)

(21) Appl. No.: 13/110,083

(22) Filed: May 18, 2011

Related U.S. Application Data
(62) Division of application No. 12/542,041, filed on Aug. 17, 2009.
Application No. 12/542,041 is a continuation-in-part of application No. 10/526,835, filed on Mar. 5, 2005, now abandoned.

(51) Int. Cl. G06Q 40/00

(52) U.S. Cl. 705/39

(57) ABSTRACT

The method of reducing emissions of a pollutant by relying on a novel endogenous futures market to set the pollutant emission fees. The individual marginal cost (m1) is known by actors, companies, individuals or actors for reducing one emission unit of the pollutant. The current market rate of the futures price (n1) for an emission unit is determined by the market. The emission fee (s1) during a certain time period (for instance; month) in the future is set by law or decree to be the same as the price of the futures contract on a certain expiry date in advance of the above mentioned time period to ensure genuine uncertainty of (s1).

### PRIOR APPLICATIONS

This application is a divisional patent application that claims priority from continuation-in-part patent application Ser. No. 12/542,041 filed 17 Aug. 2009 that claims priority from U.S. national phase application Ser. No. 10/526,835, filed 5 Mar. 2005 that is based on International Application No. PCT/US03/27357, filed 29 Aug. 2003, claiming priority from US Provisional Patent Application Ser. No. 60/319,526, filed 8 Sep. 2002.

### FIELD OF INVENTION

The method of the present invention is for establishing a novel endogenous futures market for fees on pollutant emissions.

### BACKGROUND OF INVENTION

The fees on pollutant emissions charged by governments have, historically, been strongly biased by political considerations which have kept them relatively low and made them less efficient. It is important to set the fees or taxes on pollutant emissions in a way that correctly balances the various economic and environmental forces in a modern society. In general, it is ineffective to charge companies too much because, among other things, that may result in capital destruction, misdirected and inefficient use of resources and a slowdown in economic growth since most taxes and fees are passed on to the consumers. It is also ineffective not to charge enough because that may promote excessive pollution, destruction of natural resources and environment and a lowering of companies' willingness to invest in pollutant emissions reducing equipment and technology. Governments have been struggling with the task of how to set the correct fee without much success since the emission fees must change in time as the economic conditions and pollution situation change. Efforts have been made to set fixed amounts of total pollutant emissions that are acceptable to society. Companies are then allocated shares or permitted emission quantities so that a company may emit up to the allowable emission quantity limit without being penalized. The allocated companies may then trade the emission quantities or the permission to emit. One drawback is that the politically biased fixed total amount of emissions and the company allocations may be far from optimal. It may also be complicated to develop a fair sanction or penalty system when a company has exceeded its allowable emission quantity. There is a need for an effective and reliable way of setting the correct emission fees that does not promote excessive pollution or hinder economic growth.

### SUMMARY OF INVENTION

The present invention provides a solution to the above outlined problems. More particularly, the present invention is a method of reducing the emitted quantity of a pollutant by relying on the market forces to set the emission fee charged for emissions of that pollutant. The various (individual) marginal costs for reducing the emissions by one unit of the pollutant are known by companies, individuals or actors. The current market price of futures for an emission unit is then determined by the actions of buying and selling contracts on the market. Although the emission fee is regularly set by law or decree to be the same as the closing price on the expiry date of the corresponding futures contract there is still genuine uncertainty about the level of the emission fee in the future. The polluter, and/or any other market actor, is then free to compare their own individual marginal or alternative cost with the futures price. If the marginal or alternative cost is less than the futures cost, the polluter, and/or any other actor, is free to invest in pollution reducing equipment, or to choose some other profitable alternative, and to sell futures at the current market price. At the end of the contract term, or earlier if needed, the polluter, and/or any other actor on the market, may buy back the futures. On the other hand, if the marginal or alternative cost is higher than the futures cost, the polluter, and/or any other actor, is equally free to buy futures at the current market price. At the end of the contract term the polluter, and/or any other actor, accordingly, is free to sell back the futures. The total cost for the emission fees paid and the futures trading can show a loss or a profit. The company that invested in pollution reducing equipment makes a profit from the futures trading when the futures cost is reduced, which encourages such investments and reduces the risk. The polluter may compare his own marginal cost (m1) with the futures price (n1). If the marginal cost is less than the futures price, the polluter is free to choose to invest in pollution reducing equipment and sell futures at the current market price. On the other hand if the marginal cost (m1) is higher than the futures price (n1), the polluter is equally free not to invest in pollution reducing equipment but instead buy futures at the current market price. A third equally free option is not to take any action. Acting on the endogenous futures market is completely non-compulsory. The only compulsory feature of the proposed method is the payment of the emission fee. The most cost effective way of charging the fee is upstream on the production, extraction and/or import of the relevant substance directly or indirectly.

### BRIEF DESCRIPTION OF DRAWINGS

FIG. 1 is a schematic flow diagram of the method of the present invention; and

FIG. 2 is a schematic flow diagram showing the relationships of the participants of the method of the present invention.

### DETAILED DESCRIPTION

The present invention is a method of using the market forces in a new and unique way to determine emission fees for the purpose of internalizing the cost of pollutant emissions reductions in the economy.

One important new principle of the present invention is the removal of the underlying commodity, stock or asset, i.e. there is no underlying primary spot market. The present invention may therefore be defined as an endogenous futures market. It is submitted that the persons skilled in the art have not understood this principle since common knowledge claims that without an underlying commodity, stock or asset and a spot market, a futures market would become like a casino and trading would become a game of pure hazard. However, it has been surprisingly discovered that since there are real costs associated with emissions reduction and since a real and compulsory pollution fee will exist, by definition, there is a fundamental economic driving force affecting the market actors although there is no underlying commodity. Furthermore, there is a genuine uncertainty which is one of the prerequisites for a viable market.

If the market price, at a certain time, were to be considerably lower than the average cost of emissions reduction there would be an incentive for the majority (of fee paying companies) to hedge against a rising price by buying contracts. On the other hand, if the market price, at a certain time, was to be considerably higher than the average cost of emissions reduction there would be an incentive for the majority (of fee paying companies) to take action to reduce their emissions, at a lower cost than the market price, and at the same time hedge against a falling price by selling contracts.

Since the market actors have individual, and different, alternative costs for emissions reduction, there will be incentives both to sell and to buy and to invest or not to invest in clean technology in order to reduce the cost and the conditions for a functioning market are present. The actions of the market actors reveal the aggregated marginal cost on the endogenous futures market which is an expression of the endogenous futures process. Thus, the present invention is based on a new way of thinking, contrary to the established paradigm, and a new way of applying market forces to the reduction of pollutant emissions. The present invention achieves a reduction that is efficient not only in the spatial distribution of emissions reduction but also in the temporal distribution of emissions reduction. In other words, the emissions reduction process being efficient not only concerning the amount of emissions reduction but also concerning the rate of emissions reduction. The novel market of the present invention is aimed at finding the average emissions reduction cost of pollutant emissions so that there will be an economic driving force that is sufficient to achieve a balanced change to cleaner technology at a rate that is not so fast that is will cause capital destruction, with high costs, yet fast enough not to incur costly damage to the environment.

The method of the present invention includes using a market to reduce the risk for companies or individuals in varying pollution-reduction-costs under environmental restraints. The method is using a market to ensure efficiency of pollution reductions in both space and time. The method can be combined with repayment of the accumulated fees, in part or in full, to ensure political acceptance for market driven solutions of environmental problems. All the steps of the present method are carried out by using computers and suitable software to run the computers. The method described, which is based on the endogenous futures market, opens the new possibility to utilize the market as a measuring and/or probing instrument and as a new tool in the economy.

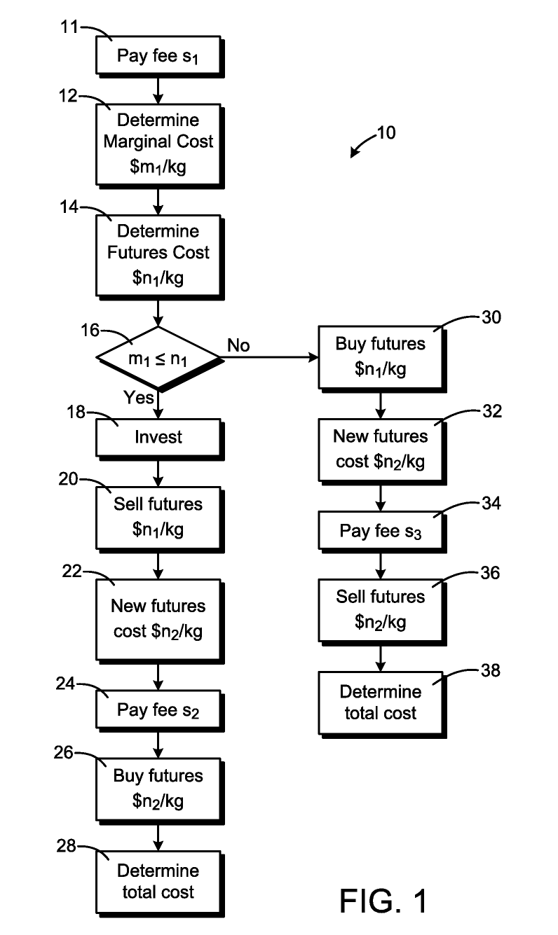

With reference to FIG. 1, the method 10 of the present invention is a system that permits fees such as a pollutant emissions fee to be paid, directly or indirectly, to the government/authorities or an environment fund. The accumulated assets in the fund can be repaid to companies and/or households, in part or in full, in order to stimulate investment in cleantech and as societal compensation. The market forces determine the emission fee in a way similar to the way the price of a futures contract for commodities is determined, although no commodity is involved in this case.

An important feature of the method of the present invention is that the pollution fee varies with the supply and demand of the market which is fundamentally linked to the cost of emissions reduction.

The method 10 includes the step 11 of using a computer for paying an emission fee (s1) for the time period (t1) by using company A's current or old equipment. The time period (t1) may be equivalent to a consumption that produces (x1) kg pollution. The fee may be an upstream payment or a downstream payment. The initial upstream payment (s1) may be a tax on fuel or chemicals as determined by a governmental authority that is added to the price of the fuel/chemicals so that the fee is an indirect cost for company A. The downstream payment may be a payment that is based on the direct emission of a pollutant. The method also includes the computer step of determining 12 company A's marginal cost (MC) by using a computer for reducing emissions, such as the emission of carbon dioxide. Company A's actual marginal cost partly depends on the age and condition of company A's current or old equipment. The marginal cost may be the cost or investment required to decrease the emissions with one kilogram (kg). The marginal cost for company A may be $m1/kg where the parameter m1 may be any monetary value.

In a second computer step 14, company A determines by using computers the futures contract cost regarding the emission of a particular pollutant in question for the particular industry. For example, the current futures market rate may be $n1/kg such as $1.00/kg. The futures cost parameter (n1) may be the average alternative cost for reducing emissions for all companies in the particular industry of company A.

In general, the companies may use the futures market for emission fees to ensure there is some guaranteed return from investments for emissions reducing technologies. For example, if a new technology is developed that dramatically lowers the cost of reducing emissions and company A has already invested in the higher cost technology, company A may benefit from the investment by selling futures at the current market price and buying back at a lower market price at the end of the contract term, as explained in detail below.

As indicated above, futures are commonly traded for commodities wherein the commodity is traded at a certain price and the futures market is normally traded at a different price. An important feature of the present invention is that the current method 10 does not involve any commodities but only an emission fee and the size of the fee itself and the price of the futures are identical since there is no underlying commodity. The present invention may therefore be defined as an endogenous futures market. In a comparison step 16 of the computer, the company determines by using the computer whether the company's marginal cost $m1/kg is less than the futures cost $n1/kg. If the marginal cost (m1) is less than the futures cost (n1), then it is advantageous for company A to invest in emissions reducing equipment, as shown in the investment step 18 that reduces the current emissions from (x1) kg/time period to (x2) kg/time period. In a computerized selling step 20, company A may reduce the investment risk by selling (x1-x2) kg of futures at the current market price of $n1/kg. As shown in computer step 22, the futures cost may change from $n1/kg to $n2/kg.

If the substance paid for in step 11 is consumed at the end of time period (t1), company A pays an indirect consumption fee (s2) by using a computer, as shown in the pay step 24, that is based on the newly reduced consumption of (x2) kg for time period (t2) since the investment in computer step 18 reduced the consumption from (x1) kg per time period or unit to (x2) kg per time period or unit. As indicated above, the fee (s2) may be charged indirectly in the form of a tax that is added to the price of the substance or chemical in question. Of course, the fee (s2) may also be a direct fee, based on actual emitted amounts.

At the expiration of the contract term, company A buys back, by using a computer, the futures sold in computer step 20 at $n2/kg, as shown in the computerized buy step 26, in view of the market change in computer step 22. In the computerized determination step 28, company A's total cost (T1) is (s1)+(s2)+(x1-x2)(n2-n1) where the parameter (x2) is smaller than the parameter (x1). The fee (s1) may be calculated as $x1*n1 and the fee (s2) may be calculated as $x2*n2. If the market price $n2/kg is lower than the old market price $n1/kg, company A has made a profit from the futures trading and the futures trading reduces the overall cost. In this way, the futures trading may be seen as an insurance in view of the extra investments made to reduce the emitted amount.

If the marginal cost $m1/kg is greater than the futures cost $n1/kg in computer step 16 then company A may reduce the risk of a higher fee in the future by buying futures at the current market price $n1/kg, as shown in the computerized buy step 30. The amount of futures is equivalent to x1 kg that is the current emissions per time contract period. In general, this can be seen as a way for the company to buy time. The market may then change the futures cost from $n1/kg to $n2/kg, as shown in computer step 32.

If the substance paid for in step 11 is fully consumed at the end of time period (t1) then company A pays a fee (s3), as shown in the computerized pay step 34, that is equivalent to the same emissions or substance consumption of x1 kg since no investment was made to reduce the emissions and thus the substance consumption so the fee (s3) may be calculated as $n2*x1 kg for the next contract period.

At the expiration of the contract term, company A may choose to sell back the futures, bought in computer step 30, at the new current market price of $n2/kg, as shown in the computerized sell step 36. In the computerized determination step 28, company A's total cost (T2) is (s1)+(s3)+x1*(n2-n1). The fee (s1) may be calculated as $x1*n1 and the fee (s3) may be calculated as $x1*n2. If the market price (n2) is lower than the market price (n1), company A has lost on the futures trading. However the cost for paying the fee is reduced also so the loss and the gain cancel out

It may be possible to return the emission fees collected by the government, such as the fees (S1), (s2) and (s3), to each individual citizen. This manner of return payment can be defined as a societal compensation that ensures that a majority of people will benefit from the method making it politically easier to introduce. The benefits and surplus effects generated through the operation of the endogenous futures market can stimulate and enhance the development and transformation to a sustainable economy.

An additional important feature of the method is that it can be introduced and established gradually by initially setting the fee by political decisions before making the market fully endogenous. This reduces the suggested market into a conventional futures market or in other words; an exogenous futures market.

### Definitions

### Endogenous Futures Market

The endogenous futures market of the present invention may be defined as a futures market without the underlying commodity, stock or asset. The endogenous futures market can be established when there is a genuine uncertainty reflected in the level of the price/kg of a pollutant emission or some other defined endogenous asset in price/unit. The present invention is an example of such a futures market that fulfils the criteria of the concept. Since there are real costs associated with emissions reduction and since a real and compulsory emission fee exists there is a fundamental economic driving force affecting the market. In other words, an endogenous futures market is a futures market where there is no normal, exogenous, asset or commodity. Instead there is, what could be called, an endogenous asset, for instance, in the form of a pollutant emission fee that is regularly set equal to the closing price on the expiry date of a futures contract on the same said pollutant emission fee.

The time period during which a fixed set fee price is valid is preferably a month but any other time period is possible. By the same logic an ordinary futures market can be defined as an exogenous futures market since there is an exogenously priced asset or commodity on a primary market or spot market. The present invention may therefore be defined as an endogenous futures market.

### Endogenously Priced Emission Fee

An endogenously priced emission fee is an emission fee which is determined by a futures market for the same said emission fee. By the same logic an ordinary emission fee can be defined as an exogenously priced emission fee since it is priced exogenously and not by the market itself.

### Endogenous Futures Process

An endogenous futures process may be reflected in the time varying price on the endogenous futures market. The process is based upon the genuine uncertainty about the fee level. This process is the main incentive for stakeholders and actors to take a position on the market. That action expressed will either fulfil the need of an insurance instrument for business enterprises or give stimulation for investment in clean technology. The endogenous futures process will then produce the necessary economic and societal stimulation effects which will have a positive impact on the economy.

### Compensation

Compensation may refer to the provision of money or its equivalents, financial or real assets, and/or goods or services capable of provision within the natural, physical or real world. Here: The flexible fee mechanism may facilitate the refunding of accumulated assets back to investment accounts, accessible for companies as compensation and stimulation in clean-tech and/or the refunding of assets back to households. The latter refunding mentioned can be defined as societal compensation.

Initial emission fee

Initial emission fee is the fee levied on a pollutant initially, by a political decision. This may only be needed at the upstart of the endogenous futures market.

Insurance function

The endogenous futures market may serve a dual purpose by both eliciting companies to predict and reveal their costs on the market as well as being a tool to insure against future unknown costs for pollutant emissions.

### Genuine Uncertainty

Genuine uncertainty is a necessary prerequisite for the stimulation and development of a free market. This, in turn, is one of the prerequisites for a viable economy. The uncertainty of the future price level (the fee level) opens a natural incentive for the creation of a secondary derivatives, market (an options market). Such a market fulfils a function as an insurance tool for the primary market.

### Process

Process may mean a process, art or method. A statutory process may be defined as any use of a process, machine, manufacture, composition of matter or material, including use as a form for services rendered.

### Statutory Compensation

Statutory compensation may refer to the provision of any one or more of the following as a form of compensation: a statutory process, a machine, a manufacture, a composition of matter, or material.

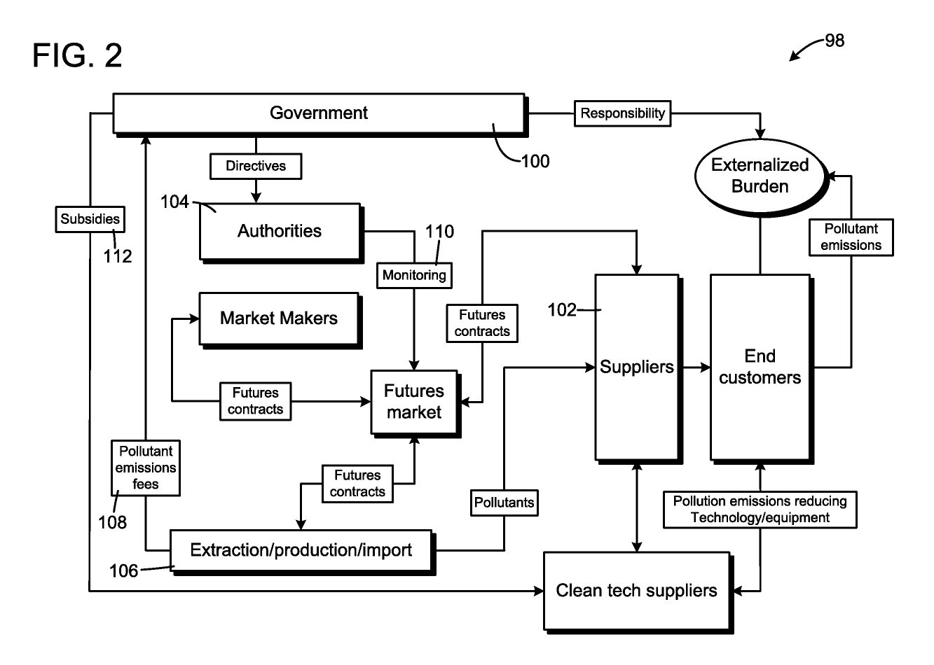

FIG. 2 shows the relationships between the participants and explanations of the roles of the participants in a system 98 of the present invention. In general, governments 100 have no mandate by law to allow eco-system or health damaging emissions in to the common atmosphere/biosphere. However, by historical precedent or because limitations would damage economic growth, emissions are allowed without negative consequences for the polluter. In economic terms this is termed externalization (to others in society) of the costs that the polluter would otherwise incur. Furthermore, there is often no mechanism by which government can easily monitor and control such emissions. Suppliers 102 of goods and services, when faced with the purchase of a pollution causing substance of a less damaging alternative are forced by economic logic to take the less expensive option. If the pollution free solution is more expensive it would put the supplier at an economic disadvantage to purchase it.

Pollutant emissions are regulated in law and monitored by authorities 104 according to the directive given them by the government 100. Faced with the alternative of allowing a certain level of pollutant emissions or placing strict limits and creating inconveniences or negative economic impact, governments 100 will, being wary of public opinion and their electorate, err on the side of convenience and economic growth. However this kind of growth is, for obvious reasons, not a sustainable, long term, growth. Pollution making substances that are not naturally occurring in abundance enter the supply chains at either the point of extraction, production or import 106. This provides the governments 100 with convenient check points. Setting a flexible pollutant emissions fee 108 gives the opportunity for the authorities 104 to effectively test the ability of the market to respond and introduce cleaner alternatives. Finally, the introduction of an endogenous futures market of the present invention for pollutant emissions fees gives the authorities a market-made evaluation 110 of the cost of emissions abatement. The transition to clean technology can further be stimulated by the transference of fees to clean technology subsidies 112.

Below is an example of the steps involved to establish a standardized endogenous futures contract of the present invention.
1. Futures Contract Object

The Emission Fee for the Futures Contract Substance for the Futures Contract Amount for the Futures Object Period.
2. Futures Contract Substance

Carbon Dioxide, CO2
3. Futures Contract Amount 1000 kg
4. Futures Object Period

The month of July in the year 2010.
5. Futures Expiry Date

The last futures contract trading day in the month of June in the year 2010.
6. Futures Contract Conditions

No physical delivery—only clearing on the expiry date.

While the present invention has been described in accordance with preferred compositions and embodiments, it is to be understood that certain substitutions and alterations may be made thereto without departing from the spirit and scope of the following claims.

1. A method for using a novel, computer controlled, endogenous futures market for monthly adjusted pollutant emission fees for an economically efficient reduction of pollutant emissions, in a spatial distribution of the emissions reduction between polluters and in a temporal distribution of emissions reduction over time, comprising:
paying endogenously priced emission fees at regular time intervals to achieve an efficient spatial distribution of the emissions reduction while simultaneously creating an economic feedback signal, beneficial for a development of sustainable, environmentally compatible, technology;
establishing an endogenous futures market, for the emission fees, thereby using a market to find and reveal a technology dependent and time dependent emissions reduction cost;
using a closing price of the futures contracts on an expiry date preceding each time interval to automatically set a level of the emission fees for the following time period, to internalize the emissions reduction cost, in the market, and controlling the technology transformation speed to achieve an efficient temporal distribution of the emissions reduction;
reimbursing a certain fraction of the emission fees, to every person, in the economy, in equal amounts, thereby making the emissions reduction control, democratically viable while simultaneously redistributing purchasing power and creating a demand for sustainable, environmentally compatible, technology.

2. The method, according to claim 1, wherein the method further comprises directly or indirectly applying the emission fees on upstream emissions.

3. The method, according to claim 1, wherein the method further comprises replacing the emission fees with production fees on chemical substances.

4. The method, according to claim 1, wherein the method further comprises replacing the emission fees with extraction fees on scarce natural resources.

5. The method, according to claim 1, wherein the method further comprises a monthly reimbursement of a certain fraction of the emission fees, to every person in a state or in a union or in a country or in a union of countries or in a group of countries, in equal amounts.

6. The method, according to claim 1, wherein the method further comprises a monthly reimbursement of a certain fraction of the emission fees, to every person, in the world, in equal amounts.

7. The method according to claim 1 wherein the method further comprises adjusting the size of the fraction, of the emission fees, reimbursed in search for an optimum.
